(19) United States
(12) Patent Application Publication
(10) Pub. No.: US 2025/0172718 A1
(43) Pub. Date: May 29, 2025

(54) PHOTOELECTRIC FUSION IN-SITU DETECTION DEVICE AND METHOD FOR THERMAL VOLATILE GASES AND THERMAL EVOLUTION STAGES OF UNDERGROUND OIL SHALE

(71) Applicant: JILIN UNIVERSITY, Jilin (CN)

(72) Inventors: Zhiyong CHANG, Jilin (CN); Cheng KONG, Jilin (CN); Chengxin SONG, Jilin (CN); Xiangyu LUAN, Jilin (CN); Xiaohui WENG, Jilin (CN); Zongwei YAO, Jilin (CN); Tao ZHANG, Jilin (CN); Ruochen AN, Jilin (CN); Sunhua DENG, Jilin (CN)

(73) Assignee: JILIN UNIVERSITY, Jilin (CN)

(21) Appl. No.: 18/520,402

(22) Filed: Nov. 27, 2023

(51) Int. Cl. G01V 9/00; E21B 49/08; G01V 11/00

(52) U.S. Cl. CPC G01V 9/007; E21B 49/081; G01V 11/002

(57) ABSTRACT

The present disclosure relates to a dust-removed odor sampling device for oil shale and a photoelectric fused method for underground in-situ exploration and thermal evolution stage monitoring of oil shale, belonging to the technical field of oil shale in-situ exploration and exploitation. The present disclosure includes: establishing an dust-removed odor sampling device, which includes an imitation sandfish lizard dustproof chamber, an imitation leaf filter membrane, a single-chip microcomputer controller, a dust collection box, a solenoid valve and an air pump; using a redesigned FB score and a feature selection algorithm to optimize a gas sensor array and reduce the apparatus volume and energy consumption; and combining the optimized gas sensor array with the optical gas detector to realize the underground in-situ exploration and thermal evolution stage monitoring of oil shale by the photoelectric fusion method.

### BACKGROUND

### Technical Field

The present disclosure belongs to the technical field of oil shale in-situ exploration and exploitation, and in particular, relates to a photoelectric fusion in-situ detection device and method for thermal volatile gases and thermal evolution stage (i.e., cracking state) of underground oil shale.

### Description of Related Art

Oil shale is a sedimentary rock rich in kerogen organic matter, which is expected to be commercially developed through in-situ conversion technology and can be used as a supplementary energy source for traditional oil and gas. The oil shale has huge reserves on earth, and the exploitation and utilization of the oil shale are mainly affected by the effect of exploration and the thermal evolution stage monitoring of oil shale during exploitation. On the one hand, exploration of oil shale can evaluate the abundance of organic matter inside the oil shale, and type and evolution of the kerogen, so as to determine the exploitation value of the mine and guide subsequent exploitation. On the other hand, real-time thermal evolution stage monitoring of oil shale is conducive to quickly correcting the heating and pressure control process, reducing costs and improving energy return rate. Therefore, underground in-situ exploration and thermal evolution stage monitoring of oil shale are conducive to achieving accurate evaluation of oil shale deposit value and real-time monitoring of the mining process, guiding the selection of on-site conversion technology and regulation of the engineering process, to assist the efficient exploitation of underground oil and gas resources.

Traditional exploration and evaluation of oil shale generally rely on on-site geological survey, drilling coring and further laboratory testing and analysis. The methods widely used for qualitative or quantitative monitoring of cracking process of oil shale include directly measuring vitrinite reflectance of rock samples, using spectral techniques to analyze structure and composition of rock, and establishing a numerical simulation method based on dynamic data obtained from pyrolysis experiments or data from actual mining. At present, these methods for the underground in-situ exploration and the thermal evolution stage monitoring of oil shale usually require complex sample preparation and analysis in the laboratory, which is time-consuming, expensive and cannot meet the requirements of in-situ real-time monitoring.

The organic matter type, abundance, maturity and thermal evolution stage of oil shale can be accurately judged and monitored in real time through the qualitative and quantitative accurate detection of oil shale with different qualities and a multi-component gas generated in the process of cracking. As a rapidly developing gas detection technology, a gas sensor array has the advantages of high efficiency, fast speed, low cost, simple operation, and on-site real-time detection, and so on, and is receiving increasing attention in energy field. Optical gas detection technology converts a signal of gas molecules interacting with photons into an electrical signal, which has the advantages of good selectivity, high sensitivity, strong stability, and short response time and has been widely used in real-time monitoring of various gases in various environments. By using the gas sensor array and the optical gas detection technology, it is expected to realize rapid underground in-situ exploration and real-time thermal evolution stage monitoring of oil shale. However, the application of the two gas detection technologies in the field of in-situ exploration and in-situ real-time thermal evolution stage monitoring of oil shale still faces three key technical problems that need to be solved urgently. Firstly, in the process of the underground in-situ exploration and thermal evolution stage monitoring of oil shale, particles such as rock debris will adhere to surfaces of gas-sensitive detectors and an optical apparatus, which will affect the accuracy of the sensors and greatly damage the effect of exploration and monitoring. Secondly, too many sensors are easy to cause problems such as large apparatus volume and high energy consumption, which is not conducive to assembling of apparatus during oil shale exploration and exploitation. More importantly, currently the gas sensor arrays alone or the optical gas detection apparatus alone cannot achieve reliable underground in-situ exploration and thermal evolution stage monitoring of oil shale due to key technical defects. On the one hand, although the gas sensor arrays can detect the multi-component gas in real-time, they have a low accuracy and a high detection limit for single specific gases. On the other hand, although the optical gas detection technology provides more accurate detection results for the single specific gases, its real-time detection of the multi-component gas requires the use of a tunable light sources capable of covering a absorption wavelength of the multi-component gas or direct use of a spectrometer for detection. However, these devices have a larger volume and a higher cost than a light source emitting a fixed wavelength, and the tunable light source emitting a limited range of wavelengths cannot guarantee the detection of all types of gases in the multi-component gas.

### SUMMARY

The present disclosure proposes a real-time and reliable device and method for underground in-situ exploration and thermal evolution stage monitoring of oil shale using bionics and machine learning technology. In order to solve the problem of rock debris particle interference, the chamber structure was optimized in dustproof sampling by a biomimetic technology using biological properties. The sandfish lizard is a desert animal living in an environment with a lot of sand and dust particles. The special structure of its nasal cavity can enable the sand particles inhaled into the nasal cavity to be blocked in a specific area at the front of the nasal cavity, the sand particles that are blocked and gathered in the nasal cavity are ejected from the body through intense coughing and exhalation. Therefore, the nasal structure of the sandfish lizard and the behavior of vigorous exhalation to remove sand particles from the nasal cavity are applied to the sampling chamber structure and sampling method of a multi-gas-sensitive sensing system. A large number of plant leaves have a unique structure that enables them to capture particles in the air, and at the same time, a large number of stomas distributed on surfaces of the leaves have the ability to intercept and block particles while enriching the particles on the leaves. Therefore, a biomimetic flexible filter membrane is combined for secondary filtration to ensure that the sensor array is not affected by fine particles and achieve dust sampling in multiple gas sensing systems. A large number of plant leaves have unique structures that enable leaves to capture particles in the air. At the same time, a large number of pores distributed on the surface of the leaves have the ability to intercept and block particles while enriching the particles. Therefore, a biomimetic flexible filter membrane is combined for secondary filtration to ensure that the sensor array is not affected by fine particles and achieve dustproof sampling of the multi-gas-sensitive sensing system. In order to solve the problem of large apparatus size and high energy consumption, a FB score in machine learning is redesigned to achieve an optimal balance between the accuracy of oil shale state detection and the number of sensors deployed, a CatBoost algorithm is used to sort the features according to the importance of output features, and then sort the sensors to remove a redundant sensor, and is integrated with a feature selection algorithm to further improve classification performance and stability. In order to solve the problem of the poor reliability when monitoring using a gas sensor array or an optical gas detection technology alone, the gas sensor array and an optical gas detector are organically combined for photoelectric fusion detection, and the optimized gas sensor array and the optical gas detector are placed underground for in-situ real-time exploration and thermal evolution stage monitoring of oil shale. An optimized gas sensor array combined with the optical gas detector is used to jointly detect a multi-component gas generated in a process of cracking of oil shale, and an XGBoost classifier, random forest regression analysis algorithm, support vector machine regression analysis algorithm and convolutional neural network classifier are used to determine organic matter type, abundance, maturity and thermal evolution stage of oil shale. At the same time, when the cracking of oil shale enters an organic matter decomposition stage, a heating temperature and formation pressure are rapidly adjusted in real time according to a methane concentration measured by the optical gas detector in real time so as to control a reaction process of underground in-situ conversion of organic matter in the oil shale and improve energy return rate.

To achieve the above objects, the following technical solutions are adopted in the present disclosure:
A. imitation sandfish lizard dustproof chamber; B. imitation leaf filter membrane; C. single chip microcomputer controller; D. dust collection box; a1. jack I; a2. jack II; a3. jack III; a4. jack IV; c1. control unit; c2. signal acquisition unit;
1. solenoid valve I; 2. air pump; 3. solenoid valve II; 4. air inlet channel; 5. diffusion channel; 6. dust settlement channel; 7. sensing channel; 8. dust collection channel; 9. dust passage pipe; 10. dust collection chamber; 11. filter screen; 12. gas-sensitive sensor array; 13. A/D acquisition module (analog-to-digital acquisition module, for converting an analog signal into a digital signal); 14. touch display screen; 15. power supply.

1. A dust-removed odor sampling device for oil shale, which includes an imitation sandfish lizard dustproof chamber (A), an imitation leaf filter membrane (B), a single-chip microcomputer controller (C), a dust collection box (D), a solenoid valve I (1), an air pump (2), and a solenoid valve II (3), where the solenoid valve I (1), the imitation sandfish lizard dustproof chamber (A), the imitation leaf filter membrane (B), the single-chip microcomputer controller (C), the air pump (2), and the solenoid valve II (3) are arranged sequentially from front to rear;
the imitation sandfish lizard dustproof chamber (A) is a three-way pipe, on which an air inlet channel (4), a diffusion channel (5), a dust settlement channel (6), a sensing channel (7) and a dust collection channel (8) are provided, an upper part of the sensing channel (7) is provided with a jack I (a1), a jack II (a2), a jack III (a3) and a jack IV (a4) of a gas-sensitive sensor array (12); the air inlet channel (4) is a circular cross-section straight pipe with an inner diameter d1=10-12 mm; the diffusion channel (5) is an inclined pipe formed by lofting a front circular cross-section and a rear circular cross-section, where centers of circles of the front and rear cross-sections are at a same horizontal line and the circles are tangent to each other, an inner diameter of the front cross-section is d1=10-12 mm, and an inner diameter of the rear cross-section is d2=28-30 mm;
the dust settlement channel (6) is formed by lofting a front circular cross-section and a rear semi-circular cross-section, centers of circles of the front and rear cross-sections are concentric, and inner diameters of the front and rear cross-sections are d2=28-30 mm; the sensing channel (7) is a circular cross-section bend pipe with an inner diameter d4=10-12 mm and an outer diameter d5=12-14 mm; distances between centers of circles of the jack I (a1), jack II (a2), jack III (a3) and jack IV (a4) are L1=15-18 mm, inner diameters of them are d3=8-9 mm, and heights of all jacks in relative to height of center of cross-section of the air inlet channel are L2=60-62 mm; the dust collection channel (8) is formed by lofting an upper elliptical cross-section and a lower circular cross-section, and circles of the upper and lower cross-sections are tangent to each other in their rear directions;
the single-chip microcomputer controller (C) includes a control unit (c1), a signal acquisition unit (c2), a touch display screen (14), and a power supply (15), where the control unit (c1) includes the solenoid valve I (1) and the solenoid valve II (3); the signal acquisition unit (c2) includes the gas-sensitive sensor array (12) and an A/D acquisition module (13); the control unit (c1), the signal acquisition unit (c2), and the touch display screen (14) are connected to the power supply (15) through wires;
the dust collection box (D) includes a dust passage pipe (9), a dust collection chamber (10), and a filter screen (11), where the dust passage pipe (9) is fixedly connected to and communicated with a center of an upper end of the dust collection chamber (10), and the filter screen (11) is fixedly connected to a lower end of the dust collection chamber (10); an upper end of the dust passage pipe (9) is threaded to a lower end of the dust collection channel (8), an outer diameter of the dust collection chamber (10) as cylinder is d6=40-45 mm, and a diameter of mesh of the filter screen (11) is d7=0.3-0.5 mm;
the solenoid valve I (1) is communicated with the air inlet channel (4) of the imitation sandfish lizard dustproof chamber (A); the gas-sensitive sensor array (12) is fixedly connected to the jack I (a1), jack II (a2), jack III (a3) and jack IV (a4) respectively of the sensing channel (7) of the imitation sandfish lizard dustproof chamber (A);
the air pump (2) is communicated with a rear part of the sensing channel (7) of the imitation sandfish lizard dustproof chamber (A);
the dust collection box (D) is communicated with a lower part of the dust collection channel (8) in the imitation sandfish lizard dustproof chamber (A) through the solenoid valve II (3);
the single-chip microcomputer controller (C) is connected with the solenoid valve I (1) and the solenoid valve II (3) through wires, the single-chip microcomputer controller (C) is connected with the gas-sensitive sensor array (12) and powered through the power supply (15), and a voltage signal transformation generated by the gas-sensitive sensor array is collected, recorded and stored through the A/D acquisition module (13).

2. A production method of an imitation leaf filter membrane (B) is characterized by including the following steps:
step S1: mixing a PDMS polymer and a curing agent at a ratio of 10:1, and adding them to solvent FC-43 at 20 wt % for mechanical stirring for 10 min,
step S2: applying solution prepared in step S1 to a pure silicon mold with a pit array, and then placing the mold into a microwave oven for 3 min of radiation,
step S2 specifically includes: the pure silicon mold has a height of L5=25-30 mm, an inner slot thereof has a diameter of d8=10-12 mm and a height of L7=15-20 mm, and distances between centers of cells of a cylindrical cell array arranged in the inner slot are L4=15-20 μm, depths of the cells are L6=6-8 μm and diameters of the cells are d9=12-16 μm,
the single-chip microcomputer controller (C) includes a control unit (c1), a signal acquisition unit (c2), a touch display screen (14) and a power supply (15), where the control unit (c1) includes a solenoid valve I (1) and a solenoid valve II (3); the signal acquisition unit (c2) includes a gas-sensitive sensor array (12) and an A/D acquisition module (13); the control unit (c1), the signal acquisition unit (c2) and the touch display screen (14) are connected to a power supply (15) through wires.

3. The dust-removed odor sampling device for oil shale where the imitation sandfish lizard dustproof chamber (A) is a three-way pipe, on which an air inlet channel (4), a diffusion channel (5), a dust settlement channel (6), a sensing channel (7) and a dust collection channel (8) are provided, an upper part of the sensing channel (7) is provided with a jack I (a1), a jack II (a2), a jack III (a3) and a jack IV (a4) of a gas-sensitive sensor array (12); the air inlet channel (4) is a circular cross-section straight pipe with an inner diameter d1=10-12 mm; the diffusion channel (5) is an inclined pipe formed by lofting a front circular cross-section and a rear circular cross-section, where centers of circles of the front and rear cross-sections are at a same horizontal line and the circles are tangent to each other, an inner diameter of the front cross-section is d1=10-12 mm, and an inner diameter of the rear cross-section is d2=28-30 mm;
the dust settlement channel (6) is formed by lofting a front circular cross-section and a rear semi-circular cross-section, centers of circles of the front and rear cross-sections are concentric, and inner diameters of the front and rear cross-sections are d2=28-30 mm; the sensing channel (7) is a circular cross-section bend pipe with an inner diameter d4=10-12 mm and an outer diameter d5=12-14 mm; distances between centers of circles of the jack I (a1), jack II (a2), jack III (a3) and jack IV (a4) are L1=15-18 mm, inner diameters of them are d3=8-9 mm, and heights of all jacks in relative to height of center of cross-section of the air inlet channel are L2=60-62 mm; the dust collection channel (8) is formed by lofting an upper elliptical cross-section and a lower circular cross-section, and circles of the upper and lower cross-sections are tangent to each other in their rear directions;
the dust collection box (D) includes a dust passage pipe (9), a dust collection chamber (10), and a filter screen (11), where the dust passage pipe (9) is fixedly connected to and communicated with a center of an upper end of the dust collection chamber (10), and the filter screen (11) is fixedly connected to a lower end of the dust collection chamber (10); an upper end of the dust passage pipe (9) is threaded to a lower end of the dust collection channel (8), an outer diameter of the dust collection chamber (10) as cylinder is d6=40-45 mm, and a diameter of mesh of the filter screen (11) is d7=0.3-0.5 mm.

4. A photoelectric fusion method for underground in-situ exploration and thermal evolution stage monitoring of oil shale where the method is based on the dust-removed odor sampling device for oil shale discussed above, and specifically includes the following steps:
step 4.1, according to composition of a volatile gas of oil shale and a change process of a concentration of a gas component during thermal evolution stage, taking a gas whose concentration changes significantly with decomposition of organic matter of oil shale as a target gas of an optical gas detector, and recording the target gas as G;
step 4.2, constructing the optical gas detector, which includes: a laser, a gas absorption pool, a detector, a laser driver, a signal generator, a lock-in amplifier, and a data acquisition card;
step 4.3, constructing an initial gas sensor array: according to type of a gas compound volatilized from oil shale in different states, selecting other gas sensor except the target gas G in step 4.1, to construct an initial gas senor array that is capable of monitoring all heat volatile gases, where the different states of oil shale include organic matter abundance, kerogen type and thermal evolution stage;
step 4.4, obtaining, by using the initial gas sensor array constructed in step 4.3, effective odor data, including the following steps:
step 4.4.1, constructing a signal acquisition system by using the initial gas sensor array, together with an air pump, a mass flow controller, a filter noise reduction circuit and a data acquisition instrument, and heating oil shale sample according to a heat-injection in-situ mining method of oil shale; converting, by the signal acquisition system, an odor into numerical data that is easy to be processed, where n odor samples are collected and recorded as set S={s₁, s₂, s₃, . . . , sₙ};
step 4.4.2, obtaining the thermal evolution stage of oil shale through an accurate laboratory measurement, recording it as set L={l₁, l₂, . . . , lₖ}, and corresponding it to the odor samples to form a training set T={s₁^{l}, s₂^{l}, s₃^{l}, . . . , sₙ^{l}}, where l∈L;
step 4.5, extracting and fusing multi-phase features of the training set of oil shale, including the following steps:
step 4.5.1, extracting, by a plurality of steady-state feature extraction methods, a steady-state feature of each sample to form a steady-state feature vector, which is recorded as Fₛ;
step 4.5.2, extracting, by a plurality of transient feature extraction methods, a transient feature of each sample to form a transient feature vector, which is recorded as Fₜ;
step 4.5.3, fusing the steady-state feature vector and the transient feature vector extracted from each sample to form a final feature vector F=(Fₛ, Fₜ);
step 4.6, sorting each feature in the final feature vector based on its importance, including the following steps:
step 4.6.1, calculating the importance of each feature by using a filtering method in feature selection and sorting each feature;
step 4.6.2, calculating the importance of each feature by using an embedding method in feature selection and sorting each feature;
step 4.6.3, sorting each feature by obtaining an average value and combining sequence numbers obtained by multiple sorting methods to obtain a final sorting of features;
step 4.7, utilizing F_{β}′score to achieve selection of an optimal feature subset, including the following steps:
step 4.7.1, recognizing, by using numerous classifiers in machine learning, a state of oil shale on the training set to determine a classifier with best recognition effect and use it as a feature subset selection classifier, where a 10-fold cross-validation is used for evaluation in an evaluation process of the classifiers;
step 4.7.2, generating different number of feature subsets based on sorting of the features, and evaluating each feature subset by an improved FB score,

$${F}_{β}^{′} = ( 1 + {β}^{2} ) \times \frac{\frac{d - m}{d - 1} \times accuracy}{( {β}^{2} \times \frac{d - m}{d - 1} ) + accuracy} ,$$

where d is feature number in the final feature vector F, m is feature number in the feature subset, accuracy is an recognition rate of an established model for state prediction of oil shale, and β is an optimization parameter representing a relative importance of the recognition rate and the feature number;
step 4.8, finding gas sensors corresponding to features in the optimal feature subset, to jointly form an optimized sensor array;
step 4.9, establishing a photoelectric fused system for underground in-situ exploration and thermal evolution stage monitoring of oil shale: a miniaturized sensor array obtained after optimizing the sensor array, together with the optical gas detector, a cooling device, a temperature sensor, a pressure sensor, an oil shale underground in-situ conversion heating device, and a formation pressure control device constitute the photoelectric fused system for underground in-situ exploration and thermal evolution stage monitoring of oil shale;
step 4.10, using the photoelectric fused system for underground in-situ exploration and thermal evolution stage monitoring of oil shale to realize underground in-situ exploration of oil shale, including the following steps:
step 4.10.1, for oil shales with different kerogen types, measuring their kerogen types accurately in laboratory, to constitute a label set, which is recorded as set G₁={g₁¹, g₂¹, g₃¹, . . . , gₖ¹}, and meanwhile, collecting, by using the photoelectric fused system for underground in-situ exploration and thermal evolution stage monitoring of oil shale, volatile gas information of oil shale, which is recorded as set H₁={h₁¹, h₂¹, h₃¹, . . . , hₖ¹}, and combining G₁ and H₁ to constitute a training set J₁={jₕ_{₁}_{¹}^{g}, jₕ_{₂}_{¹}^{g}, jₕ_{₃}_{¹}^{g}, . . . , jₕ_{ₖ}_{¹}^{g}}, where g∈G₁;
step 4.10.2, extracting features of the set J₁ using a feature extraction method to constitute a feature set, which is recorded as Fⱼ¹;
step 4.10.3, constructing, by using a bionic intelligent mode recognition method and taking the feature Fⱼ¹ as input, a classification model, which is recorded as A₁, for determining type of organic matter kerogen of oil shale;
step 4.10.4, for oil shales with different abundances, measuring their abundances accurately in laboratory, to constitute a label set, which is recorded as set G₂={g₁², g₂², g₃², . . . , gₖ²}, and meanwhile, collecting, by using the photoelectric fused system for underground in-situ exploration and thermal evolution stage monitoring of oil shale, volatile gas information of oil shale, which is recorded as set H₂={h₁², h₂², h₃², . . . , hₖ²}, and combining G₂ and H₂ to constitute a training set, J₂={jₕ_{₁}_{²}^{g}, jₕ_{₂}_{²}^{g}, jₕ_{₃}_{²}^{g}, . . . , jₕ_{ₖ}_{²}^{g}}, where g∈G₂;
step 4.10.5, extracting features of the set J₂ using a feature extraction method to constitute a feature set, which is recorded as Fⱼ²;
step 4.10.6, constructing, by using a regression analysis method and taking the feature Fⱼ² as input, a prediction model, which is recorded as A₂, for determining abundance of organic matter of oil shale;
step 4.10.7, for oil shales with different maturities, measuring their maturity stages and maturity values accurately in laboratory, where the maturity stages constitute a label set, which is recorded as set G₃={g₁³, g₂³, g₃³, . . . , gₖ³}, the maturity values constitute a label set, which is recorded as set G₄={g₁⁴, g₂⁴, g₃⁴, . . . , gₖ⁴}, and meanwhile, collecting, by using the photoelectric fused system for underground in-situ exploration and thermal evolution stage monitoring of oil shale, volatile gas information of oil shale, which is recorded as set H₃={h₁³, h₂³, h₃³, . . . , hₖ³}, combining G₃ and H₃ to constitute a training set, J₃={jₕ_{₁}_{³}^{g}, jₕ_{₂}_{³}^{g}, jₕ_{₃}_{³}^{g}, . . . , jₕ_{ₖ}_{³}^{g}}, where g∈G₃; and combining G₄ and H₃ to constitute a training set J₄={jₕ_{₁}_{⁴}^{g}, jₕ_{₂}_{⁴}^{g}, jₕ_{₃}_{⁴}^{g}, . . . , jₕ_{ₖ}_{⁴}^{g}}, where g∈G₄;
step 4.10.8, extracting features of the set J₃ using a feature extraction method to constitute a feature set, which is recorded as Fⱼ³;
step 4.10.9, constructing, by using a bionic intelligent mode recognition method and taking the feature Fⱼ³ as input, a classification model, which is recorded as A₃, for determining maturity stage of organic matter of oil shale;
step 4.10.10, extracting features of the set J₄ using a feature extraction method to constitute a feature set, which is recorded as Fⱼ⁴;
step 4.10.11, constructing, by using a regression analysis method and taking the feature Fⱼ⁴ as input, a prediction model, which is recorded as A₄, for determining maturity of organic matter of oil shale;
step 4.10.12, heating an oil shale undergoing underground in-situ exploration, and converting, by using the photoelectric fused system for underground in-situ exploration and thermal evolution stage monitoring of oil shale, odor into numerical data, which is easy to be processed and recorded as sample x;
step 4.10.13, extracting a feature of a sample x using a feature extraction method and recording it as Fₓ;
step 4.10.14, determining, by using the classification model A₁ of the type of organic matter kerogen of oil shale as constructed in step 4.10.3 and taking the feature Fₓ as input, the type of organic matter kerogen of oil shale belongs to which one of kerogen types I, II and III;
step 4.10.15, determining, by using the prediction model A₂ of the abundance of organic matter of oil shale as constructed in step 4.10.6 and taking the feature Fₓ as input, the abundance of organic matter of oil shale;
step 4.10.16, determining, by using the classification model A₃ of the maturity stage of organic matter of oil shale as constructed in step 4.10.9 and taking the feature Fₓ as input, the maturity of organic matter of oil shale is in which stage of three stages, i.e., dehydration, organic matter decomposition and semi-coke mineral decomposition;
step 4.10.17, determining, by using the prediction model A₄ of the maturity of organic matter of oil shale as constructed in step 4.10.11 and taking the feature Fₓ as input, the maturity of organic matter of oil shale;
step 4.10.18, according to the kerogen type, abundance, maturity stage and maturity value of organic matter of oil shale obtained in steps 4.10.14 to 4.10.17, evaluating mineral value of oil shale accurately and guiding on-site conversion technology selection and engineering process design to assist efficient in-situ exploitation of underground oil and gas resources;
step 4.11, using the photoelectric fused system for underground in-situ exploration and thermal evolution stage monitoring of oil shale to realize underground in-situ thermal evolution stage monitoring of oil shale, including the following steps:
step 4.11.1, monitoring a pyrolysis process of oil shale undergoing underground in-situ conversion, and converting, by using the photoelectric fused system for underground in-situ exploration and thermal evolution stage monitoring of oil shale, odor information into numerical data, which is easy to be processed and recorded as sample w;
step 4.11.2, extracting a feature of a sample w using a feature extraction method and recording it as F_{w};
step 4.11.3, determining, by using the classification model A₃ of maturity stage of organic matter of oil shale as constructed in step 4.10.9 and taking the feature F_{w} as input, maturity of organic matter of oil shale is in which stage of three stages, i.e., dehydration, organic matter decomposition and semi-coke mineral decomposition;
step 4.11.4, if the maturity of organic matter of oil shale as determined in step 4.11.3 is in stage of the organic matter decomposition, then separately analyzing a gas concentration signal of the target gas G obtained by a mid-infrared laser gas sensing system in the photoelectric fused system for underground in-situ exploration and thermal evolution stage monitoring of oil shale, where an unit time is recorded as o, a set constituted by p unit times is recorded as O={o₁, o₂, o₃, . . . , oₚ}, an average concentration of the target gas G in each unit time o is used as a representative gas concentration in this unit time and its set is recorded as C={c₁, c₂, c₃, . . . , cₚ}, and a change rate of concentration of the target gas G in each unit time o is recorded and its set is recorded as R={r₁, r₂, r₃, . . . , rₚ};
step 4.11.5, if rᵢ>rᵢ₋₁, where 1<i<m, and 2<m≤p, where p represents the number of unit time, then adjusting the oil shale underground in-situ conversion heating device and the formation pressure control device to increase an underground in-situ conversion heating temperature and formation pressure of oil shale, with subsequent steps as follows:
step 4.11.5.1, if rᵢ₊₁>rᵢ, where 1<i<m, and 2<m≤p, where p represents the number of unit time, then maintaining the underground in-situ conversion heating temperature and the formation pressure of oil shale;
step 4.11.5.2, if rᵢ₊₁≤rᵢ, where 1<i<m, and 2<m≤p, where p represents the number of unit time, then adjusting the oil shale underground in-situ conversion heating device and the formation pressure control device to increase the underground in-situ conversion heating temperature and the formation pressure of oil shale;
step 4.11.6, if rᵢ≤rᵢ₋₁, where 1<i<m, and 2<m≤p, where p represents the number of unit time, then adjusting the oil shale underground in-situ conversion heating device and the formation pressure control device to increase the underground in-situ conversion heating temperature and the formation pressure of oil shale, with subsequent steps as follows:
step 4.11.6.1, if rᵢ₊₁>rᵢ, where 1<i<m, and 2<m≤p, where p represents the number of unit time, then adjusting the oil shale underground in-situ conversion heating device and the formation pressure control device to increase the underground in-situ conversion heating temperature and the formation pressure of oil shale;
step 4.11.6.2, if rᵢ₊₁≤rᵢ, where 1<i<m, and 2<m≤p, where p represents the number of units time, then maintaining the underground in-situ conversion heating temperature and the formation pressure of oil shale.

The beneficial effects of the disclosure are as follows:

1. Breathing type dust-removed gas collection can ensure stable pressure drop of gas collection flow and meanwhile reduce interference of particles to the gas-sensitive sensor, and in process of discharging gas, it may discharge the rock debris particles blocked in the sampling chamber into the dust collection box outside the chamber, effectively clean the chamber to make it clean and collect the rock debris particles, so that the multi-gas-sensitive sensor system can work effectively for a long time.

2. The gas sensor array is optimized through a data-driven manner to significantly reduce the number of sensors, thereby reducing the volume and working energy consumption of the monitoring apparatus.

3. The photoelectric fused system is used to carry out the underground in-situ exploration and thermal evolution stage monitoring of oil shale, which ensures the accuracy and real-time performance of the exploration and the thermal evolution stage monitoring, and controls the volume and cost of the overall apparatus while meeting high precision.

### BRIEF DESCRIPTION OF THE DRAWINGS

FIG. 1 is a left view of a dust-removed odor sampling device for oil shale.

FIG. 2 is a cross-sectional view of an imitation sandfish lizard dustproof chamber.

FIG. 3 is a side view of the imitation sandfish lizard dustproof chamber.

FIG. 4 is a cross-sectional view of a dust collection box.

FIG. 5 is a schematic diagram of composition of a single-chip microcomputer controller.

FIG. 6 is a schematic diagram of a processing template for an imitation leaf filter membrane.

FIG. 7 is a flow chart of an efficient optimization method for an underground in-situ detection gas sensor array of oil shale.

FIG. 8 is a schematic diagram of feature importance sorting.

FIG. 9 is a schematic diagram of composition of a photoelectric fused system for underground in-situ exploration and thermal evolution stage monitoring of oil shale.

FIG. 10 is a schematic diagram of underground in-situ exploration of oil shale.

FIG. 11 is a schematic diagram of photoelectric fused thermal evolution stage monitoring of oil shale.

FIG. 12 is a flow chart of temperature and pressure regulation in in-situ mining of oil shale.

### DESCRIPTION OF EMBODIMENTS

In order to make the purpose, technical solution and advantages of the disclosure more clear, the implementation solution of the disclosure is further described in detail in conjunction with the accompanying drawings.

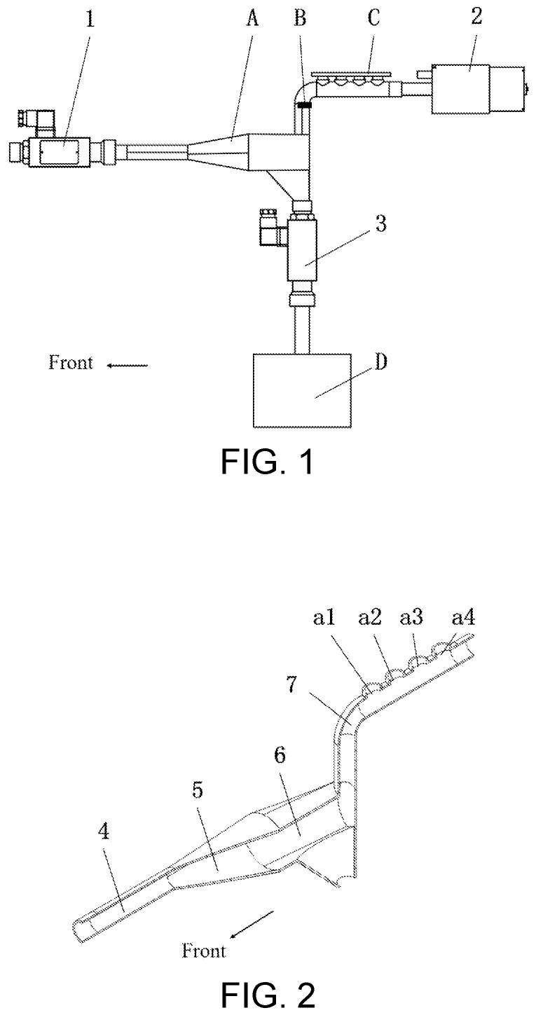

As is shown in FIG. 1, the dust-removed odor sampling device for oil shale includes an imitation sandfish lizard dustproof chamber (A), an imitation leaf filter membrane (B), a single-chip microcomputer controller (C), a dust collection box (D), a solenoid valve I (1), an air pump (2), and a solenoid valve II (3), where the solenoid valve I (1), the imitation sandfish lizard dustproof chamber (A), the imitation leaf filter membrane (B), the single-chip microcomputer controller (C), the air pump (2), and the solenoid valve II (3) are arranged sequentially from front to rear; the solenoid valve I (1) is in communication with the air inlet channel (4) of the imitation sandfish lizard dustproof chamber (A); the gas-sensitive sensor array (12) is respectively fixedly connected to the jack I (a1), jack II (a2), jack III (a3) and jack IV (a4) of the sensing channel (7) of the imitation sandfish lizard dustproof chamber (A); the air pump (2) is in communication with the rear of the sensing channel (7) of the imitation sandfish lizard dustproof chamber (A); the dust collection box (D) is connected to a lower part of the dust collection channel (8) in the imitation sandfish lizard dustproof chamber (A) through the solenoid valve II (3).

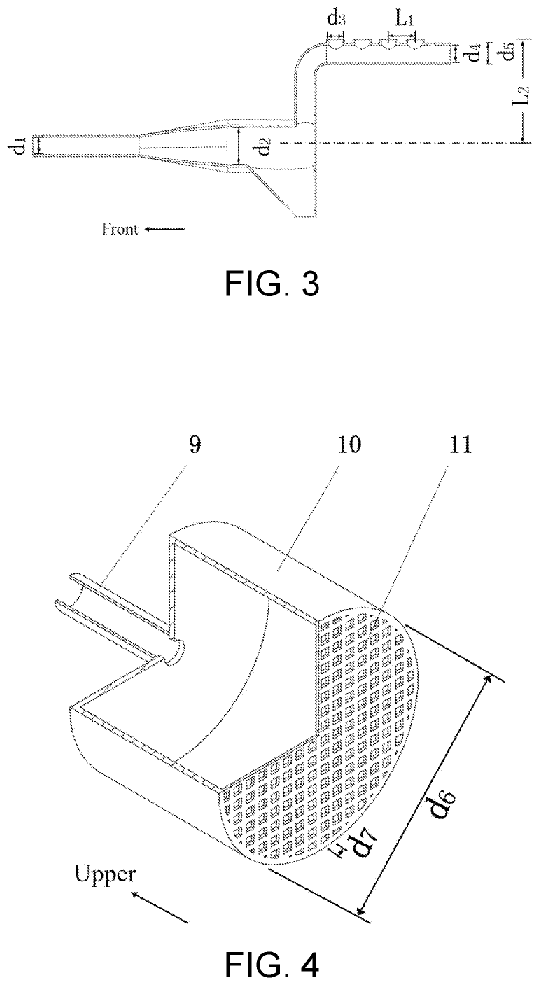

As shown in FIGS. 1 to 3, the imitation sandfish lizard dustproof chamber (A) is in a three-way pipe shape, and are provided with the air inlet channel (4), a diffusion channel (5), a dust settlement channel (6), the sensing channel (7) and the dust collection channel (8), an upper part of the sensing channel (7) is provided with the jack I (a1), the jack II (a2), the jack III (a3) and the jack IV (a4) of the gas-sensitive sensor array (12); the air inlet channel (4) is a circular cross-section straight pipe with an inner diameter d1=10-12 mm; the diffusion channel (5) is an inclined pipe formed by lofting a front circular cross-section and a rear circular cross-section, where centers of circles of the front and rear cross-sections are at the same horizontal line and the circles are tangent to each other, an inner diameter of the front cross-section is d1=10-12 mm, and an inner diameter of the rear cross-section is d2=28-30 mm; the dust settlement channel (6) is formed by lofting the front circular cross-section and the rear semi-circular cross-section, centers of circles of the front and rear cross-sections is concentric, and inner diameters of the front and rear cross-sections are d2=28-30 mm; the sensing channel (7) is a circular cross-section bend pipe with an inner diameter d4 of 10-12 mm and an outer diameter d5 of 12-14 mm; distances L1 between circles of the jack I (a1), jack II (a2), jack III (a3) and jack IV (a4) are 15-18 mm, inner diameters d3 are 8-9 mm, and heights L2 of all jacks in relative to center of cross-section of the air inlet channel are 60-62 mm; the dust collection channel (8) is formed by lofting an upper elliptical cross-section and a lower circular cross-section, and circles in the rear direction of the upper and lower cross-sections are tangent to each other.

As is shown in FIG. 4, the dust collection box (D) includes a dust passage pipe (9), a dust collection chamber (10), and a filter screen (11), where the dust passage pipe (9) is fixedly connected to center of an upper end of the dust collection chamber (10) and communicated therewith, and the filter screen (11) is fixedly connected to a lower end of the dust collection chamber (10); an upper end of the dust passage pipe (9) is threaded to a lower end of the dust collection channel (8), an outer diameter of the dust collection chamber (10) as cylinder is d6=40-45 mm, and a mesh diameter d7 of the filter screen (11) is 0.3-0.5 mm.

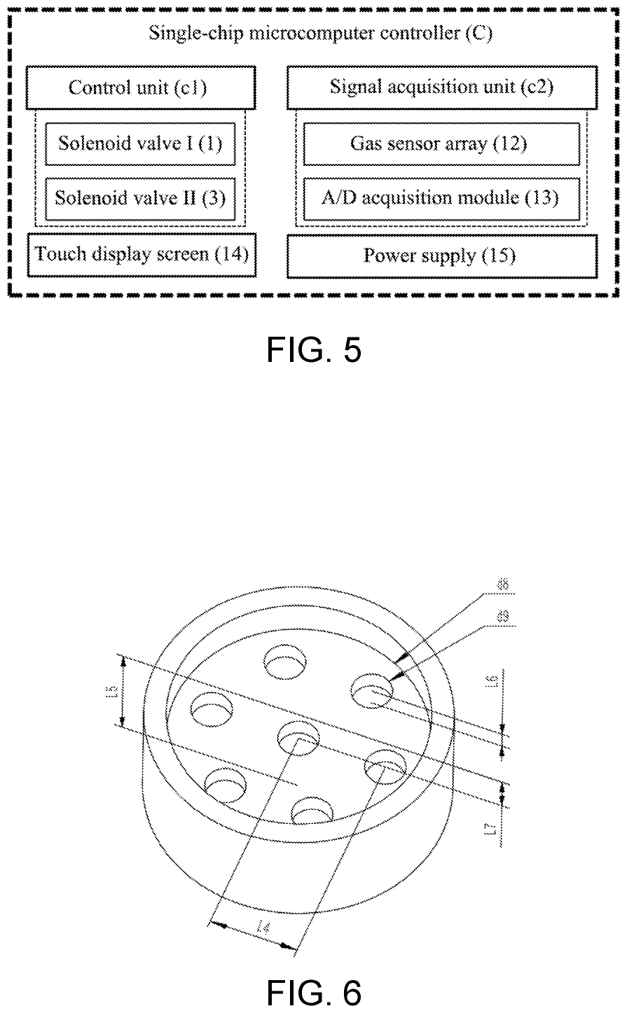

As is shown in FIG. 5, the single-chip microcomputer controller (C) is connected with the solenoid valve I (1) and the solenoid valve II (3) through wires, the single-chip microcomputer controller (C) is connected with the gas-sensitive sensor array (12) and powered through the power supply (15), and change in voltage signal generated by the gas-sensitive sensor array is collected, recorded and stored through an A/D acquisition module (13). The single-chip microcomputer controller (C) includes a control unit (c1), a signal acquisition unit (c2), a touch display screen (14) and a power supply (15), where the control unit (c1) includes a solenoid valve I (1) and a solenoid valve II (3); the signal acquisition unit (c2) includes a gas-sensitive sensor array (12) and the A/D acquisition module (13); the control unit (c1), the signal acquisition unit (c2) and the touch display screen (14) are connected to the power supply (15) through wires.

As is shown in FIG. 6, a production method of the imitation leaf filter membrane (B) includes the following steps:
step S1: mixing PDMS polymer and a curing agent at a ratio of 10:1, and adding them to solvent FC-43 at 20 wt % for mechanical stirring for 10 min.
step S2: applying the solution prepared in step S1 to a pure silicon mold with a pit array, and then placing the mold in a microwave oven for radiation for 3 min.

The step S2 specifically includes: the pure silicon mold has a height of L5=25-30 mm, an inner slot thereof has a diameter of d8=10-12 mm and a height of L7=15-20 mm, and a center distance of an internally disposed cylindrical cell array is L4=15-20 μm, a depth of the cell is L6=6-8 μm, and a diameter of the cell is d9=12-16 μm.

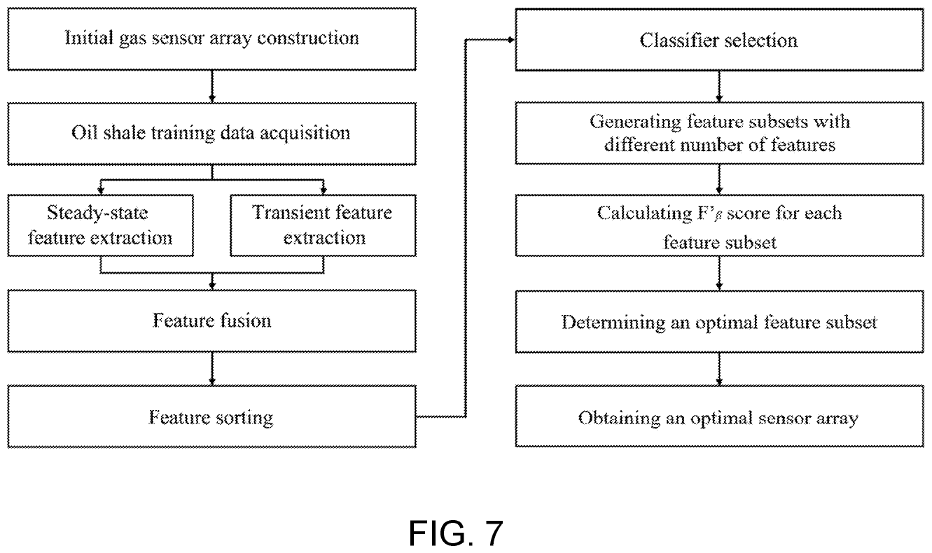

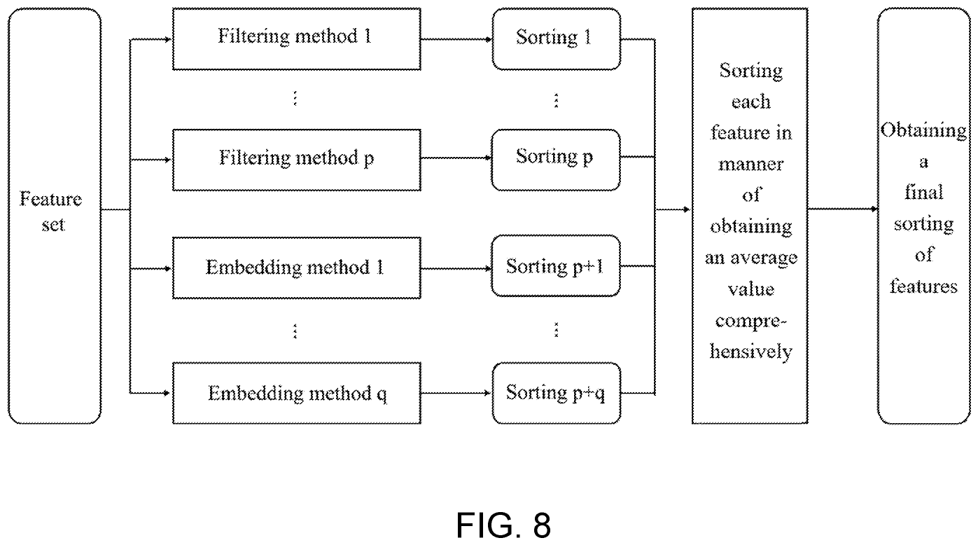

A photoelectric fusion method for underground in-situ exploration and thermal evolution stage monitoring of oil shale, which method is described by taking recognition of oil shales with different kerogen types, abundances and maturities and thermal evolution stages as an example. The method includes the following steps:
1, According to a composition of volatile gas of oil shale and a change process of gas component concentration during the thermal evolution stage, selecting methane as a target gas of an optical gas detector for underground in-situ exploration and thermal evolution stage monitoring of oil shale;
2, constructing the optical gas detector: a laser, a gas absorption pool, a detector, a laser driver, a signal generator, a lock-in amplifier, and a data acquisition card;
3, constructing an initial gas sensor array: except methane, according to type of a gas compound volatilized from oil shale in different states (different organic matter abundances, different kerogen types, different thermal evolution stages, etc.), selecting fourteen semiconductor metal oxide sensors to construct an initial gas sensor array, with initial sensor models being TGS2620, TGS2602, TGS2610, TGS2600, TGS2603, WSP1110, WSP2110, MP135, MP905, MP-7, MP-3B, MP-2, MP503, MP402;
4, obtaining, by using the initial gas sensor array constructed in step 3, oil shale odor data in different maturity states, including the following steps:
4.1, constructing a signal acquisition system by using the initial gas sensor array, together with an air pump, a mass flow controller, a filter noise reduction circuit and a data acquisition instrument, and heating an oil shale sample according to a heat injection in-situ mining method of oil shale; converting, by the signal acquisition system, an odor into numerical data that is easy to be processed, where 480 odor samples are collected;
4.2, labeling 480 odor samples, to finally obtain 210 low-mature oil shale odor samples, 210 medium-mature oil shale odor samples and 60 over-mature oil shale odor samples were obtained in total;
5, as shown in FIG. 7, performing a feature extraction on the obtained oil shale odor samples, including the following steps:
5.1, extracting maximum values, average values and integral values of the samples to reflect steady-state feature information of the samples of oil shale;
5.2, extracting, by using wavelet transform and Fourier transform, transient feature information of the samples;
5.3, enabling the extracted maximum value features, average value features, integral value features and transient feature information of the samples extracted by using wavelet transform and Fourier transform to form a final feature vector, where feature number in the feature vector is 144;
6, sorting each feature in the feature vector based on its importance, including the following steps:
6.1, calculating the importance of each feature by using a filter method (selecting correlation coefficient method and ReliefF algorithm) in feature selection and sorting each feature, where the higher the sorting is, the more important the feature is for oil shale state detection.
6.2, calculating the importance of each feature by using an embedding method (selecting XGBoost-RFE algorithm, Random Forest RFE algorithm, SVM-RFE algorithm, Logistic Regression RFE algorithm, Random Forest algorithm, CatBoost algorithm, Xgboost algorithm) in feature selection and sorting each feature, where the higher the sorting is, the more important the feature is for oil shale state detection.
6.3, as shown in FIG. 8, sorting each feature by obtaining an average value and combining sequence numbers obtained by multiple sorting methods to obtain a final sorting of features;
7, utilizing FB score to achieve selection of an optimal feature subset, including the following steps:
7.1, in order to find a best classifier, using a support vector machine, a logistic regression, a random forest, a k-nearest neighbor and a limit gradient enhancement (XGBoost) to recognize a dataset, where through comparison, it is found that XGBoost classifier has a best recognition effect on oil shale with different maturities, and thus XGBoost is chosen as a mode recognition classifier;
7.2, generating different number of feature subsets based on sorting of the features, and evaluating each feature subset by using an improved F_{β} score,

$${F}_{β}^{′} = ( 1 + {β}^{2} ) \times \frac{\frac{d - m}{d - 1} \times accuracy}{( {β}^{2} \times \frac{d - m}{d - 1} ) + accuracy} ,$$

where after data testing on β=1, 2, . . . , 10, it is found that when β=7, the best effect can be obtained, so it is finally determined that the F′₇ score is used as a selection criterion of the optimal feature subset.
8, finding gas sensors corresponding to features in the optimal feature subset, to jointly form an optimized sensor array; and performing a 10-fold cross-validation on the collected data, where an average value of finally obtained 10 results is shown in Table 1, compared with original data, the feature number is reduced by 83.33%, the sensors number is reduced by 50%, and the recognition rate is increased by 5.61%, the recognition time is reduced by 25.39%.

TABLE 1
Comparison before and after sensor array optimization

| | Sensor | Feature | Accuracy | Precision | F₁′fscore | F₇′score | Recognition |
|---|---|---|---|---|---|---|---|
| | number | number | (%) | (%) | (%) | (%) | time (s) |
| Initial sensor | 16 | 144 | 89.79 | 88.29 | 87.45 | — | 1.3617 |
| array | | | | | | | |
| Optimized | 8 ± 1 | 24 ± 5 | 93.65 | 93.90 | 93.58 | 93.42 | 1.0160 |
| sensor array | | | | | | | |

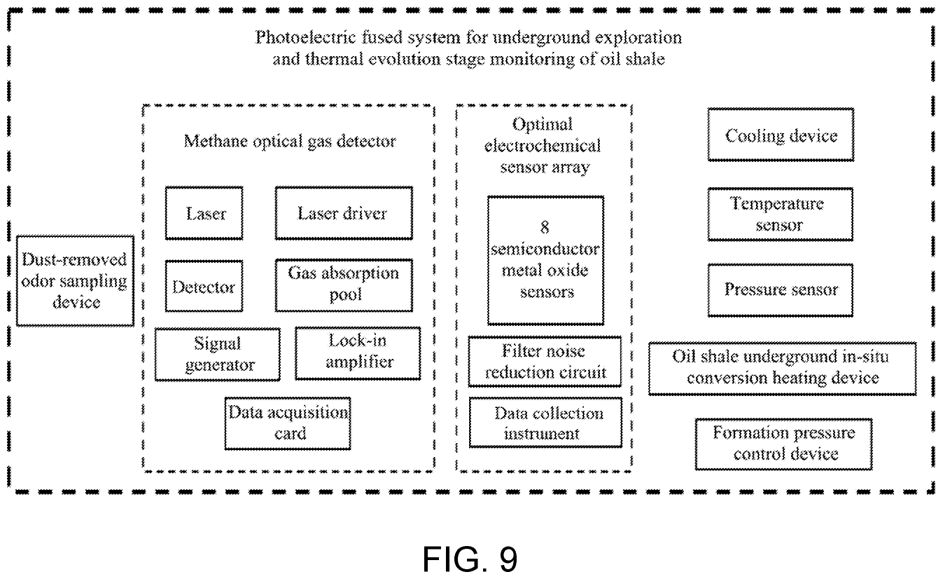

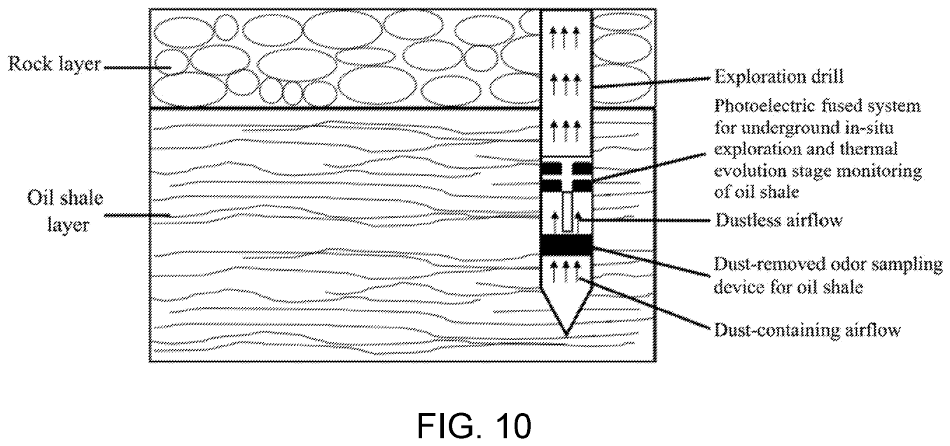

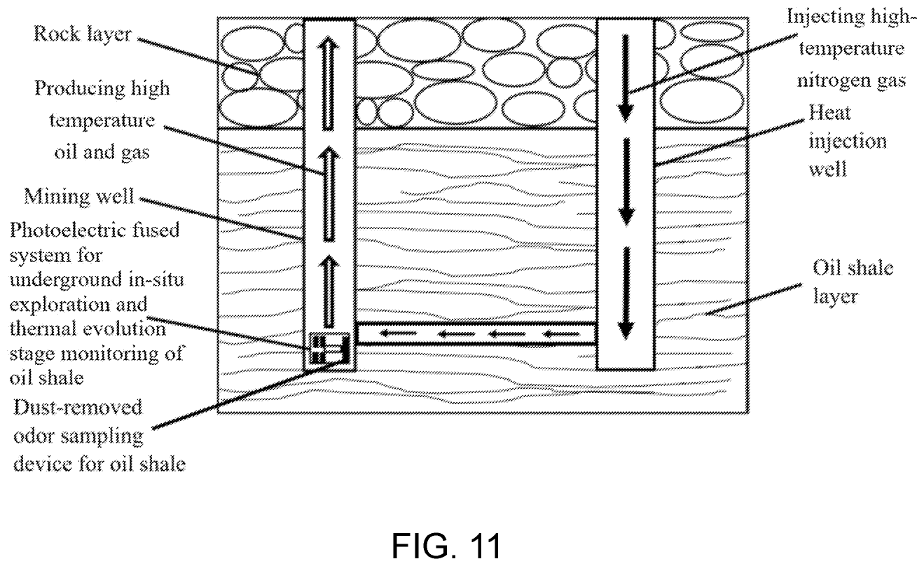

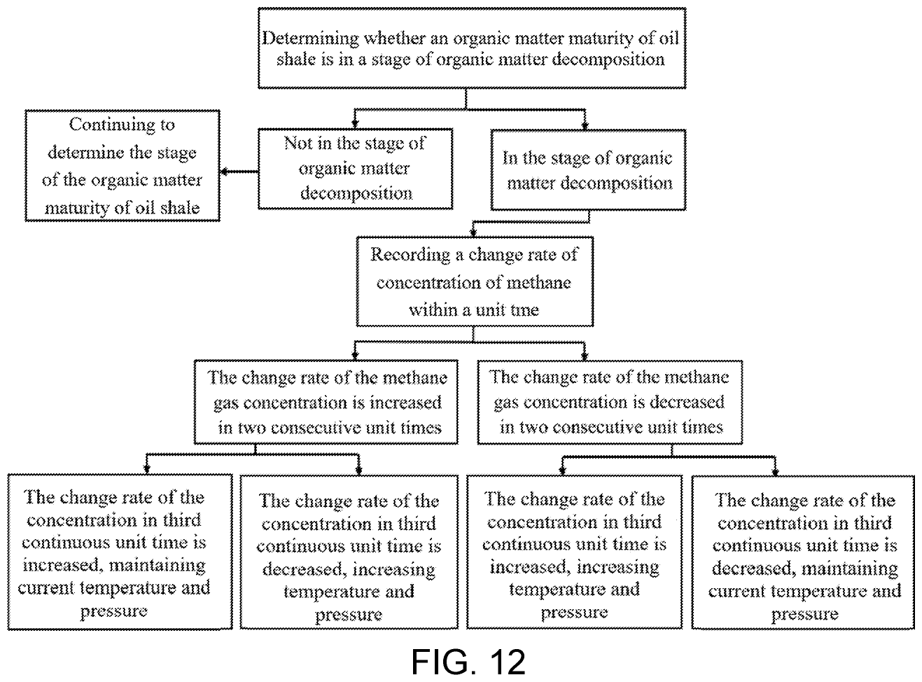

9, as shown in FIG. 9, establishing a photoelectric fused system for underground in-situ exploration and thermal evolution stage monitoring of oil shale: a miniaturized sensor array obtained after optimizing the sensor array (sensor models are TGS2602, WSP2110, MP135, MP905, MP-7, MP-3B, MP503, MP402), a methane optical gas detector, a cooling device, a temperature sensor, pressure sensor, an oil shale underground in-situ conversion heating device, and a formation pressure control device;
10, as is shown in FIG. 10, using the photoelectric fused system for underground in-situ exploration and thermal evolution stage monitoring of oil shale to realize underground in-situ exploration of oil shale, including the following steps:
10.1, accurately measuring oil shales with different kerogen types (kerogen types I, II, and III) in laboratory to obtain their kerogen types as labels, and meanwhile, heating the oil shale samples, and converting, by using the photoelectric fused system for underground in-situ exploration and thermal evolution stage monitoring of oil shale, multi-component gas odor information into numerical data that is easy to be processed, where a signal acquisition frequency is 5 Hz, and the numerical data collected each time includes 8 response data of eight semiconductor metal oxide sensors optimized by the gas sensor array, and a methane gas concentration value obtained by a methane optical gas detector through inversion of Lambert-Beer law, five data collected every 10 seconds constitute a to-be-tested sample, and each to-be-tested sample with different kerogen types contains 5×9×10=450 data points, the kerogen type labels together with the numerical data converted by the photoelectric fused system constitute a training set;
10.2, extracting, by using a maximum-value feature extraction method, steady-state features of the to-be-tested samples, to constitute a maximum-value feature set of the to-be-tested samples, where each sample contains 9 data points;
10.3, using XGBoost mode recognition method and taking the maximum-value feature set of the samples to be tested as input to construct a classification model for determining organic matter kerogen type of oil shale;
10.4, measuring accurately oil shales with different abundances in laboratory to obtain their abundances as labels, and meanwhile, heating the oil shale samples, and converting, by using the photoelectric fused system for underground in-situ exploration and thermal evolution stage monitoring of oil shale, multi-component gas odor information into numerical data that is easy to be processed, where a signal acquisition frequency is 5 Hz, and the numerical data collected each time includes 8 response data of eight semiconductor metal oxide sensors optimized by the gas sensor array and a methane gas concentration value obtained by a methane optical gas detector through inversion of Lambert-Beer law, five data collected every 10 seconds constitute a to-be-tested sample, and each to-be-tested sample with different abundances contains 5×9×10=450 data points, the oil shale abundance labels together with the numerical data converted by the photoelectric fused system constitute a training set;
10.5, extracting, by using the maximum-value feature extraction method, steady-state features of the to-be-tested samples, to constitute a maximum-value feature set of the to-be-tested samples, where each sample contains 9 data points;
10.6, constructing, by using a random forest regression analysis method and taking the maximum-value feature set of the to-be-tested samples as input, a prediction model for determining organic matter abundance of oil shale;
10.7, measuring accurately oil shales with different maturity stages (three stages, dehydration, organic matter decomposition and semi-coke mineral decomposition) in laboratory to obtain their maturity stages and maturity values as labels, and meanwhile, heating the oil shale samples, and converting, by using the photoelectric fused system for underground in-situ exploration and thermal evolution stage monitoring of oil shale, multi-component gas odor information into numerical data that is easy to be processed, where a signal acquisition frequency is 5 Hz, and the numerical data collected each time includes 8 response data of eight semiconductor metal oxide sensors optimized by the gas sensor array and a methane gas concentration value obtained by a methane optical gas detector through inversion of Lambert-Beer law, five data collected every 10 seconds constitute a to-be-tested sample, and each to-be-tested sample with different kerogen types contains 5×9×10=450 data points, the maturity stage labels together with the numerical data converted by the photoelectric fused system constitute a training set, and the maturity value labels together with the numerical data converted by the photoelectric fused system constitute a maturity value training set;
10.8, extracting, by using a maximum-value feature extraction method, steady-state features of the maturity stage training set, to constitute a maturity stage maximum-value feature set, where each sample contains 9 data points;
10.9, constructing, by using a convolutional neural network mode recognition method and taking the maturity stage maximum-value feature set as input, a classification model for determining the organic matter maturity stage of oil shale;
10.10, extracting, by using a maximum-value feature extraction method, steady-state features of the maturity value training set, to constitute a maturity value maximum-value feature set, where each sample contains 9 data points;
10.11, constructing, by using a support vector machine regression analysis method and taking the maturity value maximum-value feature set as input, a prediction model for determining the organic matter maturity of oil shale;
10.12, heating the oil shale that is undergoing underground in-situ exploration, and converting, by using the photoelectric fused system for underground in-situ exploration and thermal evolution stage monitoring of oil shale, an odor into numerical data that is easy to be processed;
10.13, extracting, by using a maximum-value feature extraction method, features of the numerical data of volatile gas of oil shale that is undergoing underground in-situ exploration as obtained in 10.12;
10.14, determining, by using the XGBoost classification mode of the organic matter kerogen type of oil shale as constructed in 10.3 and taking the feature obtained in 10.13 as input, the organic matter kerogen type of oil shale belongs to which one of kerogen types I, II and III;
10.15, determining, by using the prediction model for determining the organic matter abundance of oil shale as constructed in 10.6 and taking the feature obtained in 10.13 as input, the organic matter abundance of oil shale.
10.16, determining, by using the classification model of the organic matter maturity stage of oil shale as constructed in 10.9 and taking the feature obtained in 10.13 as input, organic matter maturity of oil shale is in which stage among three stages, dehydration, organic matter decomposition and semi-coke mineral decomposition;
10.17, determining, by using the support vector machine prediction model of the organic matter maturity of oil shale as constructed in 10.11 and taking the feature obtained in 10.13 as input, the organic matter maturity of oil shale;
10.18, according to the kerogen type, abundance, organic matter maturity stage and organic matter maturity value of oil shale as obtained in 10.14, 10.15, 10.16 and 10.17, evaluating accurately the mineral value of oil shale, guiding the selection of on-site conversion technology and engineering process design, to assist efficient in-situ exploitation of underground oil and gas resources;
11, as shown in FIG. 11, using the photoelectric fused system for underground in-situ exploration and thermal evolution stage monitoring of oil shale to realize the underground in-situ thermal evolution stage monitoring of oil shale, including the following steps:
11.1, heating the oil shale that is undergoing underground in-situ exploration, and converting, by using the photoelectric fused system for underground in-situ exploration and thermal evolution stage monitoring of oil shale, the odor into numerical data that is easy to be processed;
11.2, extracting, by using a maximum-value feature extraction method, extract features of the numerical data of volatile gas of oil shale that is undergoing underground in-situ exploration, as obtained in 11.1;
11.3, determining, by using the classification model of the organic matter maturity stage of oil shale constructed in 10.9 and taking the feature obtained in 10.13 as input, the organic matter maturity of oil shale is in which stage among three stages, i.e., dehydration, organic matter decomposition and semi-coke mineral decomposition;
11.4, as shown in FIG. 12, if the organic matter maturity of oil shale determined in 11.3 is in the stage of organic matter decomposition, then separately analyzing a concentration signal of methane gas obtained by the optical gas detector in the photoelectric fused system for underground in-situ exploration and thermal evolution stage monitoring of oil shale, where 100 s is taken as unit time and an average value of methane gas concentration within each unit time is taken as a gas concentration represented by the unit time; and meanwhile, recording a change rate of the methane gas concentration within each unit time.
11.5, if the change rate of the methane gas concentration is increased in two consecutive unit times, then adjusting the oil shale underground in-situ conversion heating device and formation pressure control device to increase the oil shale underground in-situ conversion heating temperature and formation pressure, with subsequent steps as follows:
11.5.1, if the change rate of the methane gas concentration in next continuous unit time continues to be increased, then maintaining the oil shale underground in-situ conversion heating temperature and the formation pressure;
11.5.2, if the change rate of the methane gas concentration in next continuous unit time is decreased, then adjusting the oil shale underground in-situ conversion heating device and the formation pressure control device to increase the oil shale underground in-situ conversion heating temperature and formation pressure;
11.6, if the change rate of the methane gas concentration is decreased in two consecutive unit times, then adjusting the oil shale underground in-situ conversion heating device and formation pressure control device to increase the oil shale underground in-situ conversion heating temperature and formation pressure, with subsequent steps are as follows:
11.6.1, if the change rate of the methane gas concentration in next continuous unit time is increased, then adjusting the oil shale underground in-situ conversion heating device and formation pressure control device to increase the oil shale underground in-situ conversion heating temperature and formation pressure;
11.6.2, if the change rate of the methane gas concentration in next continuous unit time is decreased, then maintaining the oil shale underground in-situ conversion heating temperature and formation pressure.

What is claimed is:

1. A dust-removed odor sampling device for oil shale, comprising an imitation sandfish lizard dustproof chamber, an imitation leaf filter membrane, a single-chip microcomputer controller, a dust collection box, a solenoid valve I, an air pump, and a solenoid valve II, where the solenoid valve I, the imitation sandfish lizard dustproof chamber, the imitation leaf filter membrane, the single-chip microcomputer controller, the air pump, and the solenoid valve II are arranged sequentially from front to rear;
the imitation sandfish lizard dustproof chamber is a three-way pipe, on which an air inlet channel, a diffusion channel, a dust settlement channel, a sensing channel and a dust collection channel are provided, an upper part of the sensing channel is provided with a jack I, a jack II, a jack III and a jack IV of a gas-sensitive sensor array; the air inlet channel is a circular cross-section straight pipe with an inner diameter d1=10-12 mm; the diffusion channel is an inclined pipe formed by lofting a front circular cross-section and a rear circular cross-section, where centers of circles of the front and rear cross-sections are at a same horizontal line and the circles are tangent to each other, an inner diameter of the front cross-section is d1=10-12 mm, and an inner diameter of the rear cross-section is d2=28-30 mm;
the dust settlement channel is formed by lofting a front circular cross-section and a rear semi-circular cross-section, centers of circles of the front and rear cross-sections are concentric, and inner diameters of the front and rear cross-sections are d2=28-30 mm; the sensing channel is a circular cross-section bend pipe with an inner diameter d4=10-12 mm and an outer diameter d5=12-14 mm; distances between centers of circles of the jack I, jack II, jack III and jack IV are L1=15-18 mm, inner diameters of them are d3=8-9 mm, and heights of all jacks in relative to height of center of cross-section of the air inlet channel are L2=60-62 mm; the dust collection channel is formed by lofting an upper elliptical cross-section and a lower circular cross-section, and circles of the upper and lower cross-sections are tangent to each other in their rear directions;
the single-chip microcomputer controller comprises a control unit, a signal acquisition unit, a touch display screen, and a power supply, where the control unit comprises the solenoid valve I and the solenoid valve II; the signal acquisition unit comprises the gas-sensitive sensor array and an analog-to-digital acquisition module; the control unit, the signal acquisition unit, and the touch display screen are connected to the power supply through wires;
the dust collection box comprises a dust passage pipe, a dust collection chamber, and a filter screen, where the dust passage pipe is fixedly connected to and communicated with a center of an upper end of the dust collection chamber, and the filter screen is fixedly connected to a lower end of the dust collection chamber; an upper end of the dust passage pipe is threaded to a lower end of the dust collection channel, an outer diameter of the dust collection chamber as cylinder is d6=40-45 mm, and a diameter of mesh of the filter screen is d7=0.3-0.5 mm;
the solenoid valve I is communicated with the air inlet channel of the imitation sandfish lizard dustproof chamber; the gas-sensitive sensor array is fixedly connected to the jack I, jack II, jack III and jack IV respectively of the sensing channel of the imitation sandfish lizard dustproof chamber;
the air pump is communicated with a rear part of the sensing channel of the imitation sandfish lizard dustproof chamber;
the dust collection box is communicated with a lower part of the dust collection channel in the imitation sandfish lizard dustproof chamber through the solenoid valve II;
the single-chip microcomputer controller is connected with the solenoid valve I and the solenoid valve II through wires, the single-chip microcomputer controller is connected with the gas-sensitive sensor array and powered through the power supply, and a voltage signal transformation generated by the gas-sensitive sensor array is collected, recorded and stored through the analog-to-digital acquisition module.

2. The dust-removed odor sampling device for oil shale according to claim 1, wherein the imitation sandfish lizard dustproof chamber is a three-way pipe, on which an air inlet channel, a diffusion channel, a dust settlement channel, a sensing channel and a dust collection channel are provided, an upper part of the sensing channel is provided with a jack I, a jack II, a jack III and a jack IV of a gas-sensitive sensor array; the air inlet channel is a circular cross-section straight pipe with an inner diameter d1=10-12 mm; the diffusion channel is an inclined pipe formed by lofting a front circular cross-section and a rear circular cross-section, where centers of circles of the front and rear cross-sections are at a same horizontal line and the circles are tangent to each other, an inner diameter of the front cross-section is d1=10-12 mm, and an inner diameter of the rear cross-section is d2=28-30 mm;
the dust settlement channel is formed by lofting a front circular cross-section and a rear semi-circular cross-section, centers of circles of the front and rear cross-sections are concentric, and inner diameters of the front and rear cross-sections are d2=28-30 mm; the sensing channel is a circular cross-section bend pipe with an inner diameter d4=10-12 mm and an outer diameter d5=12-14 mm; distances between centers of circles of the jack I, jack II, jack III and jack IV are L1=15-18 mm, inner diameters of them are d3=8-9 mm, and heights of all jacks in relative to height of center of cross-section of the air inlet channel are L2=60-62 mm; the dust collection channel is formed by lofting an upper elliptical cross-section and a lower circular cross-section, and circles of the upper and lower cross-sections are tangent to each other in their rear directions;
the dust collection box comprises a dust passage pipe, a dust collection chamber, and a filter screen, where the dust passage pipe is fixedly connected to and communicated with a center of an upper end of the dust collection chamber, and the filter screen is fixedly connected to a lower end of the dust collection chamber; an upper end of the dust passage pipe is threaded to a lower end of the dust collection channel, an outer diameter of the dust collection chamber as cylinder is d6=40-45 mm, and a diameter of mesh of the filter screen is d7=0.3-0.5 mm.

3. A production method of an imitation leaf filter membrane, comprising the following steps:
step S1: mixing a PDMS polymer and a curing agent at a ratio of 10:1, and adding them to solvent FC-43 at 20 wt % for mechanical stirring for 10 min,
step S2: applying solution prepared in step S1 to a pure silicon mold with a pit array, and then placing the mold into a microwave oven for 3 min of radiation,
step S2 comprises: the pure silicon mold has a height of L5=25-30 mm, an inner slot thereof has a diameter of d8=10-12 mm and a height of L7=15-20 mm, and distances between centers of cells of a cylindrical cell array arranged in the inner slot are L4=15-20 μm, depths of the cells are L6=6-8 μm and diameters of the cells are d9=12-16 μm,
the single-chip microcomputer controller comprises a control unit, a signal acquisition unit, a touch display screen and a power supply, where the control unit comprises a solenoid valve I and a solenoid valve II; the signal acquisition unit comprises a gas-sensitive sensor array and an analog-to-digital acquisition module; the control unit, the signal acquisition unit and the touch display screen are connected to a power supply through wires.

4. A photoelectric fusion method for underground in-situ exploration and thermal evolution stage monitoring of oil shale, wherein the method is based on the dust-removed odor sampling device for oil shale according to claim 1, and comprises the following steps:
step 4.1, according to composition of a volatile gas of oil shale and a change process of a concentration of a gas component during thermal evolution stage, taking a gas whose concentration changes significantly with decomposition of organic matter of oil shale as a target gas of an optical gas detector, and recording the target gas as G;
step 4.2, constructing the optical gas detector, which comprises: a laser, a gas absorption pool, a detector, a laser driver, a signal generator, a lock-in amplifier, and a data acquisition card;
step 4.3, constructing an initial gas sensor array: according to type of a gas compound volatilized from oil shale in different states, selecting other gas sensor except the target gas G in step 4.1, to construct an initial gas senor array that is capable of monitoring all heat volatile gases, where the different states of oil shale comprise organic matter abundance, kerogen type and thermal evolution stage;
step 4.4, obtaining, by using the initial gas sensor array constructed in step 4.3, effective odor data, comprising the following steps:
step 4.4.1, constructing a signal acquisition system by using the initial gas sensor array, together with an air pump, a mass flow controller, a filter noise reduction circuit and a data acquisition instrument, and heating oil shale sample according to a heat-injection in-situ mining method of oil shale; converting, by the signal acquisition system, an odor into numerical data that is easy to be processed, where n odor samples are collected and recorded as set S={s₁, s₂, s₃, . . . , sₙ};
step 4.4.2, obtaining the thermal evolution stage of oil shale through an accurate laboratory measurement, recording it as set L={l₁, l₂, . . . , lₖ}, and corresponding it to the odor samples to form a training set T={s₁^{l}, s₂^{l}, s₃^{l}, . . . , sₙ^{l}}, where l∈L;
step 4.5, extracting and fusing multi-phase features of the training set of oil shale, comprising the following steps:
step 4.5.1, extracting, by a plurality of steady-state feature extraction methods, a steady-state feature of each sample to form a steady-state feature vector, which is recorded as Fₛ;
step 4.5.2, extracting, by a plurality of transient feature extraction methods, a transient feature of each sample to form a transient feature vector, which is recorded as Fₜ;
step 4.5.3, fusing the steady-state feature vector and the transient feature vector extracted from each sample to form a final feature vector F=(Fₛ, Fₜ);
step 4.6, sorting each feature in the final feature vector based on its importance, comprising the following steps:
step 4.6.1, calculating the importance of each feature by using a filtering method in feature selection and sorting each feature;
step 4.6.2, calculating the importance of each feature by using an embedding method in feature selection and sorting each feature;
step 4.6.3, sorting each feature by obtaining an average value and combining sequence numbers obtained by multiple sorting methods to obtain a final sorting of features;
step 4.7, utilizing F′_{β} score to achieve selection of an optimal feature subset, comprising the following steps:
step 4.7.1, recognizing, by using numerous classifiers in machine learning, a state of oil shale on the training set to determine a classifier with best recognition effect and use it as a feature subset selection classifier, where a 10-fold cross-validation is used for evaluation in an evaluation process of the classifiers;
step 4.7.2, generating different number of feature subsets based on sorting of the features, and evaluating each feature subset by an improved F_{β} score,
$${F}_{β}^{′} = ( 1 + {β}^{2} ) \times \frac{\frac{d - m}{d - 1} \times accuracy}{( {β}^{2} \times \frac{d - m}{d - 1} ) + accuracy} ,$$
where d is feature number in the final feature vector F, m is feature number in the feature subset, accuracy is an recognition rate of an established model for state prediction of oil shale, and β is an optimization parameter representing a relative importance of the recognition rate and the feature number;
step 4.8, finding gas sensors corresponding to features in the optimal feature subset, to jointly form an optimized sensor array;
step 4.9, establishing a photoelectric fused system for underground in-situ exploration and thermal evolution stage monitoring of oil shale: a miniaturized sensor array obtained after optimizing the sensor array, together with the optical gas detector, a cooling device, a temperature sensor, a pressure sensor, an oil shale underground in-situ conversion heating device, and a formation pressure control device constitute the photoelectric fused system for underground in-situ exploration and thermal evolution stage monitoring of oil shale;
step 4.10, using the photoelectric fused system for underground in-situ exploration and thermal evolution stage monitoring of oil shale to realize underground in-situ exploration of oil shale, comprising the following steps:
step 4.10.1, for oil shales with different kerogen types, measuring their kerogen types accurately in laboratory, to constitute a label set, which is recorded as set G₁={g₁¹, g₂¹, g₃¹, . . . , gₖ¹}, and meanwhile, collecting, by using the photoelectric fused system for underground in-situ exploration and thermal evolution stage monitoring of oil shale, volatile gas information of oil shale, which is recorded as set H₁={h₁¹, h₂¹, h₃¹, . . . , hₖ¹}, and combining G₁ and H₁ to constitute a training set J₁={jₕ_{₁}_{¹}^{g}, jₕ_{₂}_{¹}^{g}, jₕ_{₃}_{¹}^{g}, . . . , jₕ_{ₖ}_{¹}^{g}}, where g∈G₁;
step 4.10.2, extracting features of the set J₁ using a feature extraction method to constitute a feature set, which is recorded as Fⱼ¹;
step 4.10.3, constructing, by using a bionic intelligent mode recognition method and taking the feature Fⱼ¹ as input, a classification model, which is recorded as A₁, for determining type of organic matter kerogen of oil shale;
step 4.10.4, for oil shales with different abundances, measuring their abundances accurately in laboratory, to constitute a label set, which is recorded as set G₂={g₁², g₂¹, g₃², . . . , gₖ¹}, and meanwhile, collecting, by using the photoelectric fused system for underground in-situ exploration and thermal evolution stage monitoring of oil shale, volatile gas information of oil shale, which is recorded as set H₂={h₁², h₂², h₃², . . . , hₖ²}, and combining G₂ and H₂ to constitute a training set, J₂={jₕ_{₁}_{²}^{g}, jₕ_{₂}_{²}^{g}, jₕ_{₃}_{²}^{g}, . . . , jₕ_{ₖ}_{²}^{g}}, where g∈G₂;
step 4.10.5, extracting features of the set J₂ using a feature extraction method to constitute a feature set, which is recorded as Fⱼ²;
step 4.10.6, constructing, by using a regression analysis method and taking the feature Fⱼ² as input, a prediction model, which is recorded as A₂, for determining abundance of organic matter of oil shale;
step 4.10.7, for oil shales with different maturities, measuring their maturity stages and maturity values accurately in laboratory, where the maturity stages constitute a label set, which is recorded as set G₃={g₁³, g₂³, g₃³, . . . , gₖ³}, the maturity values constitute a label set, which is recorded as set G₄={g₁⁴, g₂⁴, g₃⁴, . . . , gₖ⁴}, and meanwhile, collecting, by using the photoelectric fused system for underground in-situ exploration and thermal evolution stage monitoring of oil shale, volatile gas information of oil shale, which is recorded as set H₃={h₁³, h₂³, h₃³, . . . , hₖ³}, combining G₃ and H₃ to constitute a training set, J₃={jₕ_{₁}_{³}^{g}, jₕ_{₂}_{³}^{g}, jₕ_{₃}_{³}^{g}, . . . , jₕ_{ₖ}_{³}^{g}}, where g∈G₃; and combining G₄ and H₃ to constitute a training set J₄{jₕ_{₁}_{²}^{g}, jₕ_{₂}_{²}^{g}, jₕ_{₃}_{²}^{g}, . . . , jₕ_{ₖ}_{²}^{g}}, where g∈G₄;
step 4.10.8, extracting features of the set J₃ using a feature extraction method to constitute a feature set, which is recorded as Fⱼ³;
step 4.10.9, constructing, by using a bionic intelligent mode recognition method and taking the feature Fⱼ³ as input, a classification model, which is recorded as A₃, for determining maturity stage of organic matter of oil shale;
step 4.10.10, extracting features of the set J₄ using a feature extraction method to constitute a feature set, which is recorded as Fⱼ⁴;
step 4.10.11, constructing, by using a regression analysis method and taking the feature Fⱼ⁴ as input, a prediction model, which is recorded as A₄, for determining maturity of organic matter of oil shale;
step 4.10.12, heating an oil shale undergoing underground in-situ exploration, and converting, by using the photoelectric fused system for underground in-situ exploration and thermal evolution stage monitoring of oil shale, odor into numerical data, which is easy to be processed and recorded as sample x;
step 4.10.13, extracting a feature of a sample x using a feature extraction method and recording it as Fₓ;
step 4.10.14, determining, by using the classification model A₁ of the type of organic matter kerogen of oil shale as constructed in step 4.10.3 and taking the feature Fₓ as input, the type of organic matter kerogen of oil shale belongs to which one of kerogen types I, II and III;
step 4.10.15, determining, by using the prediction model A₂ of the abundance of organic matter of oil shale as constructed in step 4.10.6 and taking the feature Fₓ as input, the abundance of organic matter of oil shale;
step 4.10.16, determining, by using the classification model A₃ of the maturity stage of organic matter of oil shale as constructed in step 4.10.9 and taking the feature Fₓ as input, the maturity of organic matter of oil shale is in which stage of three stages, i.e., dehydration, organic matter decomposition and semi-coke mineral decomposition;
step 4.10.17, determining, by using the prediction model A₄ of the maturity of organic matter of oil shale as constructed in step 4.10.11 and taking the feature Fₓ as input, the maturity of organic matter of oil shale;
step 4.10.18, according to the kerogen type, abundance, maturity stage and maturity value of organic matter of oil shale obtained in steps 4.10.14 to 4.10.17, evaluating mineral value of oil shale accurately and guiding on-site conversion technology selection and engineering process design to assist efficient in-situ exploitation of underground oil and gas resources;
step 4.11, using the photoelectric fused system for underground in-situ exploration and thermal evolution stage monitoring of oil shale to realize underground in-situ thermal evolution stage monitoring of oil shale, comprising the following steps:
step 4.11.1, monitoring a pyrolysis process of oil shale undergoing underground in-situ conversion, and converting, by using the photoelectric fused system for underground in-situ exploration and thermal evolution stage monitoring of oil shale, odor information into numerical data, which is easy to be processed and recorded as sample w;
step 4.11.2, extracting a feature of a sample w using a feature extraction method and recording it as F_{w};
step 4.11.3, determining, by using the classification model A₃ of maturity stage of organic matter of oil shale as constructed in step 4.10.9 and taking the feature F_{w} as input, maturity of organic matter of oil shale is in which stage of three stages, i.e., dehydration, organic matter decomposition and semi-coke mineral decomposition;
step 4.11.4, if the maturity of organic matter of oil shale as determined in step 4.11.3 is in stage of the organic matter decomposition, then separately analyzing a gas concentration signal of the target gas G obtained by a mid-infrared laser gas sensing system in the photoelectric fused system for underground in-situ exploration and thermal evolution stage monitoring of oil shale, where an unit time is recorded as o, a set constituted by p unit times is recorded as O={o₁, o₂, o₃, . . . , oₚ}, an average concentration of the target gas G in each unit time o is used as a representative gas concentration in this unit time and its set is recorded as C={c₁, c₂, c₃, . . . , cₚ}, and a change rate of concentration of the target gas G in each unit time o is recorded and its set is recorded as R={r₁, r₂, r₃, . . . , rₚ};
step 4.11.5, if Rᵢ>Rᵢ₋₁, where 1<i<m, and 2<m≤p, where p represents the number of units time, then adjusting the oil shale underground in-situ conversion heating device and the formation pressure control device to increase an underground in-situ conversion heating temperature and formation pressure of oil shale, with subsequent steps as follows:
step 4.11.5.1, if rᵢ₊₁>rᵢ, where 1<i<m, and 2<m≤p, where p represents the number of units time, then maintaining the underground in-situ conversion heating temperature and the formation pressure of oil shale;
step 4.11.5.2, if rᵢ₊₁≤rᵢ, where 1<i<m, and 2<m≤p, where p represents the number of units time, then adjusting the oil shale underground in-situ conversion heating device and the formation pressure control device to increase the underground in-situ conversion heating temperature and the formation pressure of oil shale;
step 4.11.6, if rᵢ≤rᵢ₋₁, where 1<i<m, and 2<m≤p, where p represents the number of units time, then adjusting the oil shale underground in-situ conversion heating device and the formation pressure control device to increase the underground in-situ conversion heating temperature and the formation pressure of oil shale, with subsequent steps as follows:
step 4.11.6.1, if rᵢ₊₁>rᵢ, where 1<i<m, and 2<m≤p, where p represents the number of units time, then adjusting the oil shale underground in-situ conversion heating device and the formation pressure control device to increase the underground in-situ conversion heating temperature and the formation pressure of oil shale;
step 4.11.6.2, if rᵢ₊₁≤rᵢ, where 1<i<m, and 2<m≤p, where p represents the number of units time, then maintaining the underground in-situ conversion heating temperature and the formation pressure of oil shale.
